(19) United States
(12) Patent Application Publication
(10) Pub. No.: US 2025/0249701 A1
(43) Pub. Date: Aug. 7, 2025

(54) PUSH-ACTION COMPASS

(71) Applicant: GUANGZHOU WUSHENG STATIONERY CO.,LTD, Guangzhou (CN)

(72) Inventors: Zhehao ZHANG, Guangzhou (CN); Zhihong WANG, Guangzhou (CN); Guangqiang WU, Guangzhou (CN)

(73) Assignee: GUANGZHOU WUSHENG STATIONERY CO.,LTD, Guangzhou (CN)

(21) Appl. No.: 19/073,149

(22) Filed: Mar. 7, 2025

Related U.S. Application Data
(63) Continuation of application No. PCT/CN2023/116556, filed on Sep. 1, 2023.

(30) Foreign Application Priority Data
Sep. 7, 2022 (CN) 2022223708128

(51) Int. Cl. B43L 9/02

(52) U.S. Cl. CPC B43L 9/02

(57) ABSTRACT

A push-action compass is provided which overcomes drawbacks of conventional compasses by retracting its compass legs when not in use. The compass includes a body; a push-type telescopic assembly arranged on the body; first and second housings each connected to the body and configured to open and close relative to one another; and first and second compass legs, each sleeved by the respective housing and rotatably connected to the telescopic assembly. When the telescopic assembly is actuated, it switches between an extended state—where the tips of the compass legs protrude for use—and a retracted state—where the tips are housed within the housings to prevent accidental injury or damage.

### CROSS-REFERENCE TO RELATED APPLICATIONS

The application claims priority to Chinese patent application No. 2022223708128, filed on Sep. 7, 2022, the entire contents of which are incorporated herein by reference.

### TECHNICAL FIELD

The present invention relates generally to compasses and, more particularly, to a push-action compass that features retractable compass legs.

### BACKGROUND

Conventional compasses, as a common stationery tool, typically include two compass legs that are rotatably connected, with their distal ends respectively connected to a rotating pin and a drawing member (e.g., a pencil lead). In traditional designs, both the pin and the drawing member are exposed. When the compass is not in use, the exposed needle may inadvertently prick the user, and the pencil core is susceptible to breakage, thereby complicating safe storage of the device.

### SUMMARY

In view of the foregoing, it is an object of the present invention to provide a push-action compass that overcomes the deficiencies of conventional designs. The push-action compass of the present invention comprises a body; a push-type telescopic assembly disposed on the body; a first housing and a second housing, each connected to the body and configured to open and close relative to one another; and first and second compass legs received by the first and second housings, respectively, with the compass legs being rotatably connected to the push-type telescopic assembly. By actuating the push-type telescopic assembly, the device is switched between an extended state-where the tips of the compass legs are exposed for use-and a retracted state-where the tips are housed within the respective housings. This retraction not only protects the user from potential injury (such as being pricked by a needle) but also prevents damage to the drawing member, thereby enhancing the safety and convenience of storage.

This invention is applicable in educational, engineering, and artistic fields, offering a safer and more portable compass design compared to traditional compasses.

### BRIEF DESCRIPTION OF DRAWINGS

FIG. 1 is a schematic structural diagram of an embodiment of the push-action compass.

FIG. 2 is an exploded perspective view of the push-action compass as shown in FIG. 1.

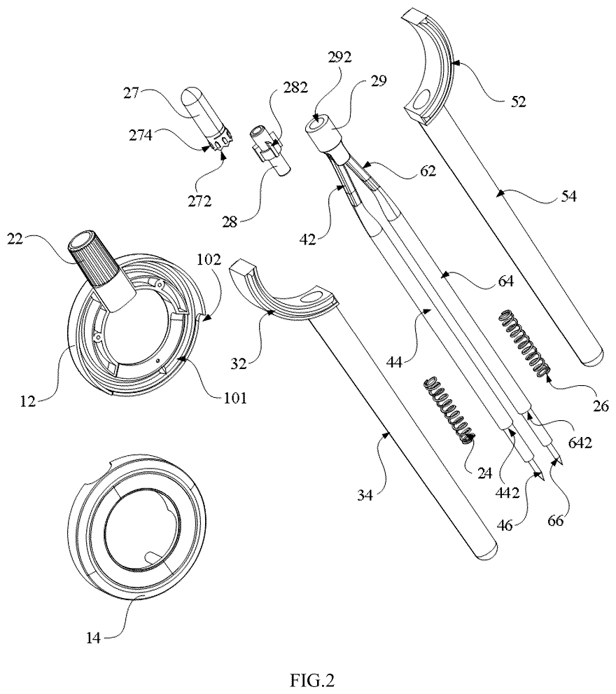

FIG. 3 is an enlarged schematic diagram illustrating one direction of the sleeve of the push-type telescopic assembly as shown in FIG. 1.

### DETAILED DESCRIPTION OF THE EMBODIMENTS

To facilitate a better understanding of the objects, technical solutions, and advantages of the present invention, a preferred embodiment is described in detail with reference to the accompanying drawings.

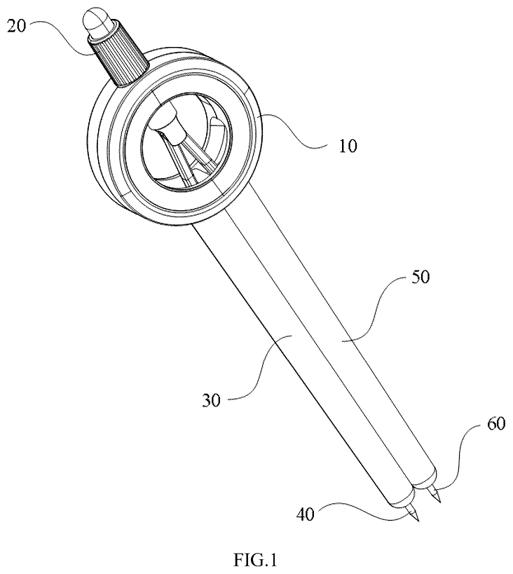

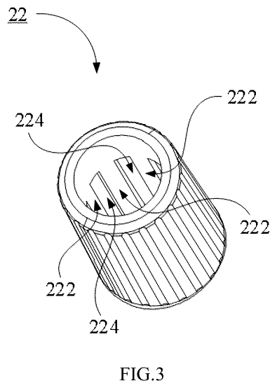

Referring to FIGS. 1 and 3, an embodiment of the push-action compass is disclosed. The embodiment comprises a body 10, a push-type telescopic assembly 20, a first housing 30, a first compass leg 40, a second housing 50, and a second compass leg 60. The push-type telescopic assembly 20 is arranged on the body 10. The first housing 30 and the second housing 50 are respectively connected to the body 10 and are configured to open and close relative to one another. The first housing 30 is mounted over the outer periphery of the first compass leg 40, and the second housing 50 is mounted over the outer periphery of the second compass leg 60. The compass legs 40 and 60 are rotatably connected and coupled to the push-type telescopic assembly 20.

By actuating the push-type telescopic assembly 20 (for example, by pressing it), the assembly is switched between an extended state and a retracted state. In the extended state, the tip of the first compass leg 40 projects from the first housing 30 and the tip of the second compass leg 60 projects from the second housing 50, thus making the device ready for use. In the retracted state, the tips of the compass legs are housed within the respective housings, thereby preventing inadvertent injury or damage.

In the illustrated embodiment, the first compass leg 40 comprises, in sequence, a first rotating segment 42, a first connecting segment 44, and a rotating pin 46, while the second compass leg 60 comprises, in sequence, a second rotating segment 62, a second connecting segment 64, and a drawing member 66. In the present embodiment, the tip of the first compass leg 40 is the rotating pin 46 (which, in one implementation, is a needle), and the tip of the second compass leg 60 is the drawing member 66 (which, in one embodiment, is an “permanent” pencil lead; alternatively, the drawing member may be a pencil core, a pencil, an automatic pencil, or a ballpoint pen). One end of the first rotating segment 42 and one end of the second rotating segment 62 are rotatably connected to the push-type telescopic assembly 20.

Since the compass legs 40 and 60 rotate relative to each other, the housings 30 and 50 must move correspondingly. To achieve this, a slide rail 101 is provided on the body 10. The slide rail 101 is arcuate or annular in shape. The first housing 30 comprises, in sequence, a first sliding member 32 and a first sleeve 34, with the first sleeve 34 mounted on the outer periphery of the first connecting segment 44. Similarly, the second housing 50 comprises a second sliding member 52 and a second sleeve 54, with the second sleeve 54 mounted on the outer periphery of the second connecting segment 64. The first and second sliding members 32 and 52 engage with the slide rail 101 so that they slide therealong, thereby allowing the housings 30 and 50 to open and close relative to each other.

Preferably, when the push-type telescopic assembly 20 is in the extended state, the rotational axis of the first rotating segment 42 and that of the second rotating segment 62 pass through or are adjacent to the center of the slide rail 101, ensuring proper alignment during operation.

In one embodiment, the body 10 comprises a first body housing 12 and a second body housing 14, with the slide rail 101 arranged on one side of the first body housing 12 and the second body housing 14 acting as a cover on that side. The first and second body housings define a receiving space in which the sliding members 32 and 52 are arranged. An arcuate opening 102 is provided on a side surface of the body 10 so that when the sliding members move along the slide rail 101, the sleeves 34 and 54 also slide along the arcuate opening.

Furthermore, in the illustrated embodiment, when the first connecting segment 44 and the second connecting segment 64 are parallel, an angle of between 5° and 30° is formed between the first rotating segment 42 and the second rotating segment 62. In other embodiments, the first and second rotating segments may be arranged parallel to one another.

The push-type telescopic assembly 20 of the present invention may comprise any suitable mechanism for switching between the extended and retracted states. In the illustrated embodiment, the operating principle of the assembly is similar to that of a push-type ballpoint pen. Specifically, the assembly 20 comprises a sleeve 22 arranged on the body 10; a first elastic element 24 disposed between the first housing 30 and the first connecting segment 44 and maintained in an elastically compressed state; a second elastic element 26 disposed between the second housing 50 and the second connecting segment 64 and maintained in an elastically compressed state; and, in sequence, a push member 27, a rotating driving member 28, and a rotating connecting member 29. Both the push member 27 and the rotating driving member 28 are arranged within the sleeve 22, and one end of the first rotating segment 42 and one end of the second rotating segment 62 are rotatably connected to the rotating connecting member 29.

As shown in FIG. 3, the inner wall of the sleeve 22 is provided with a plurality of evenly spaced rib-like protrusions 222, between which sliding grooves 224 are formed. The push member 27 is provided with a plurality of tooth-like protrusions 272 near an end adjacent to the rotating driving member 28. The outer periphery of the rotating driving member 28 is provided with a plurality of rib-like blocks 282 that match the sliding grooves 224, with the rib-like blocks 282 forming an inclined surface adjacent to the end of the push member 27 so as to mate with the tooth-like protrusions 272. When the push member 27 is actuated, the tooth-like protrusions 272 engage with the rib-like blocks 282, thereby causing the rotating driving member 28 to move downward and rotate; subsequently, the first and second elastic elements 24 and 26 jointly drive the rotating driving member 28 to return to its original position, causing the rib-like blocks 282 to engage or lock into the sliding grooves 224, thus switching the telescopic assembly 20 between its extended and retracted states.

Additionally, the push member 27 is provided on its outer periphery with a rotational blocking portion 274, and the inner wall of the sleeve 22 is provided with a corresponding rotational blocking cooperating portion (not shown) such that these features prevent any relative rotation between the push member 27 and the sleeve 22. In one embodiment, the rib-like blocks 282 are arranged on the outer periphery of a middle region of the rotating driving member 28. The push member 27 further includes a first receiving hole (not shown) near an end adjacent to the rotating driving member 28, into which one end of the rotating driving member 28 is received; a second receiving hole 292 is provided near an end of the rotating connecting member 29 adjacent to the rotating driving member 28, with the other end of the rotating driving member 28 received therein.

Finally, in the illustrated embodiment, one end of the first connecting segment 44, remote from the first rotating segment 42, is provided with a first step 442, with the first elastic element 24 received on the first connecting segment 44 at a location remote from the first rotating segment 42 such that one end of the first elastic element 24 abuts the first step 442; similarly, one end of the second connecting segment 64, remote from the second rotating segment 62, is provided with a second step 642, with the second elastic element 26 received on the second connecting segment 64 at a location remote from the second rotating segment 62 such that one end of the second elastic element 26 abuts the second step 642.

While the foregoing embodiments have been described in considerable detail for the purpose of illustration, it is to be understood that various modifications and changes may be made without departing from the spirit and scope of the invention as defined by the appended claims.

What is claimed is:

1. A push-action compass, comprising:
a main body;
a push-type telescopic assembly disposed on the main body;
a first housing and a second housing, each respectively connected to the body and configured to open and close relative to one another;
a first compass leg having an outer periphery received by the first housing; and
a second compass leg having an outer periphery received by the second housing,
wherein the first and second compass legs are rotatably connected and coupled to the push-type telescopic assembly, and
wherein actuation of the push-type telescopic assembly causes it to switch between an extended state and a retracted state, thereby driving the first compass leg to reciprocate relative to the first housing and the second compass leg to reciprocate relative to the second housing, so that when the assembly is in the retracted state, a distal end of the first compass leg is fully retracted into the first housing, and a distal end of the second compass leg is fully retracted into the second housing.

2. The push-action compass according to claim 1, wherein:
the first compass leg comprises a first rotating segment, a first connecting segment, and a rotating pin, sequentially connected;
the second compass leg comprises a second rotating segment, a second connecting segment, and a drawing member, sequentially connected;
wherein one end of the first rotating segment and one end of the second rotating segment are rotatably connected to the push-type telescopic assembly.

3. The push-action compass according to claim 2, wherein:
the main body includes a sliding rail selected from the group consisting of an arc-shaped sliding rail and an annular sliding rail;
the first housing comprises a first sliding member and a first sleeve slidably surrounding the first connecting segment;
the second housing comprises a second sliding member and a second sleeve slidably surrounding the second connecting segment;
wherein the first sliding member and the second sliding member are engaged with the sliding rail to enable relative opening and closing of the first housing and the second housing via sliding motion along the sliding rail.

4. The push-action compass according to claim 3, wherein:
in the extended state:
the distal end of the first compass leg protrudes outside the first housing, and the distal end of the second compass leg protrudes outside the second housing;
rotational axes of the first rotating segment and the second rotating segment intersect or are proximate to a center of the sliding rail.

5. The push-action compass according to claim 4, wherein:
the body comprises a first body housing and a second body housing, the slide rail being arranged on one side of the first body housing and the second body housing serving as a cover on the side of the first body housing where the slide rail is provided;
wherein the first and second body housings define a receiving space in which the first and second sliding members are arranged; and
wherein an arcuate opening is provided on a side surface of the body such that when the sliding members move along the slide rail, the first and second sleeves slide along the arcuate opening.

6. The push-action compass according to claim 2, wherein when the first connecting segment and the second connecting segment are parallel, an angle between the first rotating segment and the second rotating segment ranges from 5° to 30°.

7. The push-action compass according to claim 2, wherein the push-type telescopic assembly comprises:
a sleeve arranged on the body;
a first elastic element disposed between the first housing and the first connecting segment and maintained in an elastically compressed state;
a second elastic element disposed between the second housing and the second connecting segment and maintained in an elastically compressed state; and
sequentially connected push member, rotating driving member, and rotating connecting member,
wherein the push member and the rotating driving member are disposed within the sleeve, and one end of the first rotating segment and one end of the second rotating segment are rotatably connected to the rotating connecting member;
wherein an inner wall of the sleeve is provided with a plurality of spaced rib-like protrusions forming sliding grooves therebetween;
wherein the push member is provided with a plurality of tooth-like protrusions near an end adjacent to the rotating driving member;
wherein the rotating driving member is provided on its outer periphery with a plurality of rib-like blocks configured to mate with the sliding grooves, the rib-like blocks forming an inclined surface adjacent to the push member such that the inclined surface mates with the tooth-like protrusions; and
wherein, upon actuation of the push member, engagement between the tooth-like protrusions and the rib-like blocks drives the rotating driving member downward while causing it to rotate, after which the first and second elastic elements jointly drive the rotating driving member to return to its original position, whereby the rib-like blocks adjacent to the push member engage or lock into the sliding grooves to switch the push-type telescopic assembly between the extended and retracted states.

8. The push-action compass according to claim 7, wherein the outer periphery of the push member is further provided with a rotational blocking portion and the inner wall of the sleeve is provided with a corresponding rotational blocking cooperating portion, the rotational blocking portion and the cooperating portion functioning to prevent relative rotation between the push member and the sleeve.

9. The push-action compass according to claim 8, wherein the rib-like blocks are arranged on the outer periphery of a middle portion of the rotating driving member;
wherein the push member is provided near an end adjacent to the rotating driving member with a first receiving hole into which one end of the rotating driving member is received; and
wherein a second receiving hole is provided near an end of the rotating connecting member adjacent to the rotating driving member, with the other end of the rotating driving member received therein.

10. The push-action compass according to claim 9, wherein one end of the first connecting segment, which is remote from the first rotating segment, is provided with a first step and the first elastic element is received on the first connecting segment at a position remote from the first rotating segment such that one end of the first elastic element abuts the first step, and similarly, one end of the second connecting segment, which is remote from the second rotating segment, is provided with a second step and the second elastic element is received on the second connecting segment at a position remote from the second rotating segment such that one end of the second elastic element abuts the second step.
